(19) United States
(12) Patent Application Publication
(10) Pub. No.: US 2012/0312276 A1
(43) Pub. Date: Dec. 13, 2012

(54) ENGINE SPEED CONTROL MODE SWITCHING METHOD AND ENGINE SPEED CONTROL DEVICE

(75) Inventor: Yu Furuichi, Saitama (JP)

(73) Assignee: BOSCH CORPORATION, Tokyo (JP)

(21) Appl. No.: 13/489,150

(22) Filed: Jun. 5, 2012

(30) Foreign Application Priority Data
Jun. 10, 2011 (JP) 2011-130596

(51) Int. Cl. F02D 28/00

(52) U.S. Cl. 123/395

(57) ABSTRACT

An electronic control unit initializes, when it is determined that a switching request has been input for switching to the droop control or to the isochronous control, a value of an integral term used in PID control that is performed in the isochronous control. A target fuel injection amount set prior to switching is used for initialization. Then, the ECU calculates, using a predetermined arithmetic expression, an accelerator opening degree for use after switching of the engine speed control mode, as a virtual accelerator opening degree. The accelerator opening degree corresponds to a speed state of an engine at an accelerator opening degree used during performance of the engine speed control mode used immediately prior to switching. If the calculated virtual accelerator opening degree is greater than an actual accelerator opening degree, the ECU switches the engine speed control mode and performs isochronous control using the virtual accelerator opening degree.

### BACKGROUND OF THE INVENTION

1. Field of the Invention

The present invention relates to engine speed control of a vehicle and in particular to a device that aims to improve driving feeling when switching between control modes.

2. Description of the Related Art

In agricultural use vehicles and construction use vehicles and the like, technology is known that has, as a speed control mode for an engine, two representative control modes, namely, an isochronous control that controls engine speed such that output is constant regardless of variation in load of the engine, and a droop control that varies the engine speed in accordance with load.

It has fundamentally been the case that one of these control modes is installed depending on which is suitable given consideration of the characteristics that are required of a vehicle or the traits of a vehicle user, or both of the controls are installed in a selectively switchable manner. However, using these control modes as a base, art continues to be proposed that attempts to add measures for improving controllability from various different perspectives (for example, JP-A-2000-110635).

However, with the above-described two control modes, because a speed fluctuation rate varies with respect to the same accelerator opening degree, when switching between the control modes in vehicles in which the two control modes are switchably mounted, engine speed changes such as racing or speed decrease occur along with torque fluctuation being generated, and thus it is desirable to inhibit these changes as much as possible.

### SUMMARY OF THE INVENTION

The invention has been devised in light of the above described circumstances, and provides an engine speed control mode switching method and an engine speed control device that can smoothly switch between a droop control and an isochronous control.

According to a first aspect of the invention, there is provided an engine speed control mode switching method for use in an engine speed control device which is provided with an electronic control unit that performs operation control of an internal combustion engine and which is capable of performing speed control of the internal combustion engine by selecting and performing one of a droop control and an isochronous control in accordance with a request. The engine speed control mode switching method switches between the droop control and the isochronous control, and includes: initializing, when an engine speed control mode switching request is generated for switching from the droop control to the isochronous control, or when an engine speed control mode switching request is generated for switching from the isochronous control to the droop control, a value of an integral term used in PID control that is performed in the isochronous control only when the engine speed control mode switching request is generated for switching from the droop control to the isochronous control, the value of the integral value being initialized based on a target fuel injection quantity used immediately prior to switching, prior to performing steps below; calculating, thereafter, an accelerator opening degree in a control state after switching of the engine speed control mode, as a virtual accelerator opening degree, using a predetermined arithmetic expression, the accelerator opening degree corresponding to a speed state of the internal combustion engine at an accelerator opening degree used during performance of the engine speed control mode used immediately prior to switching of one of the engine speed control modes; then, switching the engine speed control mode if the calculated virtual accelerator opening degree is greater than an actual accelerator opening degree, and performing the engine speed control using the virtual accelerator opening degree; and after the switching, continuing the engine speed control in the engine speed control mode after switching using the actual accelerator opening degree if the actual accelerator opening degree is greater than the virtual accelerator opening degree.

According to a second aspect of the invention, there is an engine speed control device provided with an electronic control unit that performs operation control of an internal combustion engine and which is capable of performing speed control of the internal combustion engine by selecting and performing one of a droop control and an isochronous control in accordance with a request. When it is determined that an engine speed control mode switching request has been generated for switching from the droop control to the isochronous control, or when it is determined that an engine speed control mode switching request has been generated for switching from the isochronous control to the droop control, the electronic control unit initializes a value of an integral term used in PID control that is performed in the isochronous control only when it is determined that the engine speed control mode switching request has been generated for switching from the droop control to the isochronous control, the value of the integral term being initialized based on a target fuel injection quantity used immediately prior to switching, prior to performing processing below. Thereafter, the electronic control unit calculates, as a virtual accelerator opening degree, an accelerator opening degree in a control state after switching of the engine speed control mode using a predetermined arithmetic expression, the accelerator opening degree corresponding to a speed state of the internal combustion engine at an accelerator opening degree used during performance of the engine speed control mode used immediately prior to switching of one of the engine speed control modes. Then, the electronic control unit switches the engine speed control mode if the calculated virtual accelerator opening degree is greater than an actual accelerator opening degree, and performs the engine speed control using the virtual accelerator opening degree. After the switching, the electronic control unit continues the engine speed control in the engine speed control mode after switching using the actual accelerator opening degree if the actual accelerator opening degree is greater than the virtual accelerator opening degree.

### BRIEF DESCRIPTION OF THE DRAWINGS

FIG. 1 is a schematic drawing showing an example of a configuration of a common rail fuel injection control device to which an engine speed control mode switching method of an embodiment of the invention is applied;

FIG. 2 is a sub-routine flow chart showing the sequence of engine speed control mode switching processing in the embodiment of the invention that is performed by an electronic control unit used in the common rail fuel injection control device shown in FIG. 1;

FIG. 3 is a schematic characteristic diagram that schematically shows a relationship between an engine speed and a fuel injection quantity with relation to an accelerator opening degree in an isochronous control; and

FIG. 4 is a schematic characteristic diagram that schematically shows a relationship between the engine speed and the fuel injection quantity with relation to the accelerator opening degree in a droop control.

### DETAILED DESCRIPTION OF THE PREFERRED EMBODIMENTS

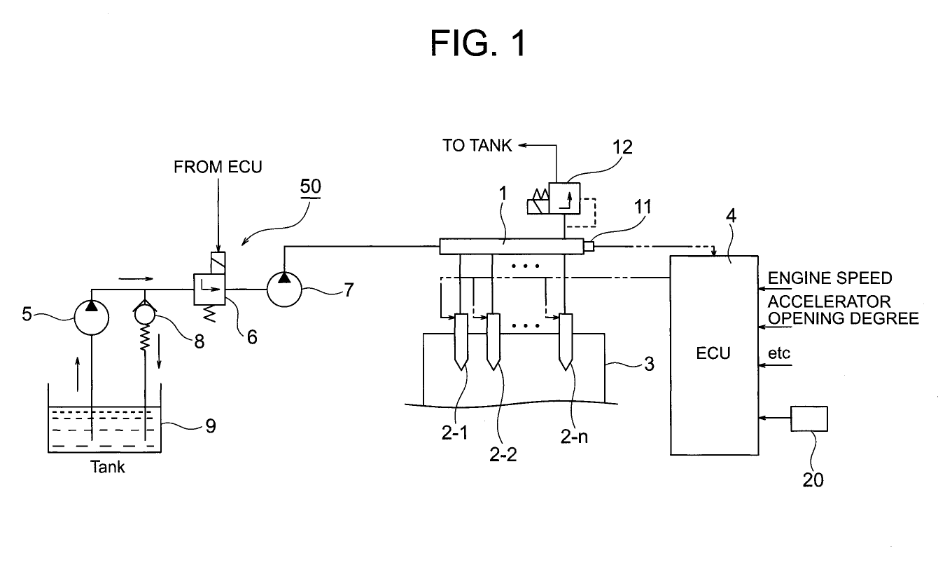

Hereinafter, an embodiment of the invention will be explained in detail with reference to FIG. 1 to FIG. 4.

It will be noted that the members and arrangements described below are not intended to limit the present invention and can be variously modified within the scope of the gist of the present invention.

First, an explanation will be given about the configuration of an internal combustion engine injection control device to which an engine speed control mode switching method of the embodiment of the invention is applied, while referring to FIG. 1.

The internal combustion engine injection control device shown in FIG. 1 is, more specifically and particularly, configured by a common rail fuel injection control device.

The common rail fuel injection control device includes, as main constituent elements, a high pressure pump device 50 that pressurizes and feeds high pressure fuel; a common rail 1 that stores the high pressure fuel that is pressure-fed from the high pressure pump device 50; a plurality of fuel injection valves (injectors) 2-1 to 2-n that inject high pressure fuel supplied from the common rail 1 to a cylinder of a diesel engine 3 (hereinafter referred to as “engine”); and an electronic control unit 4 (shown as “ECU” in FIG. 1) that performs fuel injection control processing, drive control processing of an adjustment valve described later etc.

The described configuration is the same as the fundamental configuration of already known fuel injection control devices of this type.

The high pressure fuel pump device 50 has a known configuration and includes, as main constituent elements, a feed pump 5, an adjustment valve 6, and a high pressure pump 7 as a fuel supply pump.

In the described configuration, fuel of a fuel tank 9 is sucked up by the feed pump 5, and supplied to the high pressure pump 7 via the adjustment valve 6. The adjustment valve 6 is an electromagnetic proportional control valve that has a current amount that is controlled by the ECU 4 to adjust a flow amount of the fuel supplied to the high pressure pump 7, i.e., a discharge amount of the high pressure pump 7.

Note that, a return valve 8 is provided between an outlet side of the feed pump 5 and the fuel tank 9 such that surplus fuel on the outlet side of the feed pump 5 can be returned to the fuel tank 9.

Furthermore, the feed pump 5 may be provided, as a separate body to the high pressure pump device 50, at an upstream side of the high pressure pump device 50, or alternatively may be provided inside the fuel tank 9.

The fuel injection valves (injectors) 2-1 to 2-n are provided in each cylinder of the diesel engine 3, and respectively receive supply of high pressure fuel from the common rail 1 and perform fuel injection based on injection control by the ECU 4.

In the common rail 1 of the invention, an electromagnetically controlled pressure control valve 12 is provided in a return passage (not shown in the figures) that returns surplus high pressure fuel to the fuel tank 9, and is used along with the adjustment valve 6 to control a rail pressure.

The ECU 4 is centrally formed from, for example, a micro-computer (not shown in the figures) that has a known configuration and includes, as main constituent elements, memory devices (not shown in the figures) like a RAM, a ROM etc., a drive circuit (not shown in the figures) for driving the fuel injection valves 2-1 to 2-n, and an energization circuit (not shown in the figures) for energizing the adjustment valve 6 and the pressure control valve 12.

A detection signal of a pressure sensor 11 that detects a pressure of the common rail 1 is input to the described ECU 4, as well as various types of detection signals like an engine speed, an accelerator opening degree etc. The detection signals are used in operation control, fuel injection control etc. of the engine 3.

In the embodiment of the invention, a switching input circuit 20 for switching between engine speed control modes described later is provided, and an output signal thereof is input to the ECU 4 for use in switching processing of the control modes.

The switching input circuit 20 is provided with a switch (not shown in the figures) for selecting between the two engine speed control modes described later. A signal that reflects the control mode selected by the switch is output to the ECU 4. This circuit with the described function is not specific to the invention, and a variety of permutations of circuit configuration are possible. Thus a detailed explanation of the concrete configuration of the circuit will be omitted here.

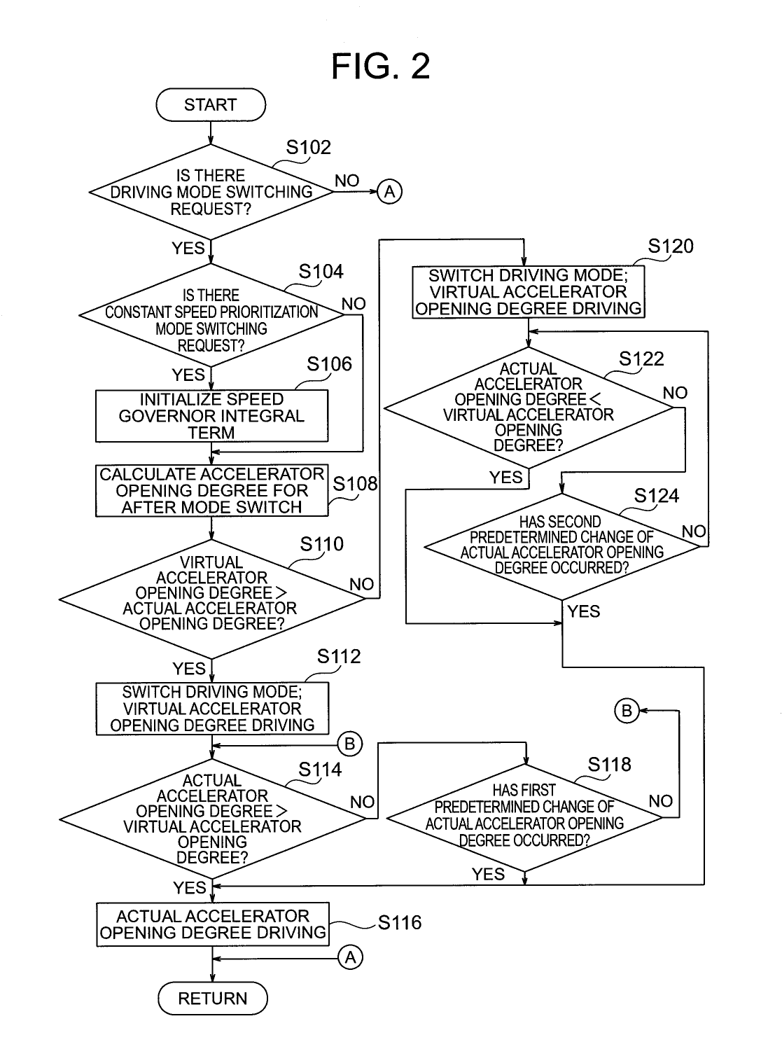

FIG. 2 shows a sub-routine flow chart of the sequence of engine speed control mode switching processing performed by the ECU 4. Below, the content of this will be explained with reference to the figure.

When the processing by the ECU 4 starts, first, it is determined whether or not a driving mode switching request, namely, a switching request for the engine speed control mode, has been generated (refer to step S102 in FIG. 2).

More specifically, in the embodiment of the invention, switching of the engine speed control mode is performed by a vehicle user operating the switching input circuit 20 to selectively choose one of two modes, namely, a “constant speed prioritization mode” and a “load following prioritization mode,” in accordance with the user's preference.

Here, the “constant speed prioritization mode” is a control that maintains the engine speed at a constant (refer to FIG. 3) regardless of load fluctuation on the engine 3, and is one type of engine speed control, namely, isochronous control.

Note that, FIG. 3 is a schematic characteristic diagram that schematically shows a relationship between the engine speed and a fuel injection quantity with relation to the accelerator opening degree in the above mentioned isochronous control.

In the figure, the horizontal axis shows an engine speed N, and the vertical axis shows a fuel injection quantity Q. Moreover, the various dotted lines are characteristic lines that schematically show changes in the fuel injection amount with respect to the engine speed at various accelerator opening degrees.

The accelerator opening degree, as shown by the two-dot chain line, increases toward the right side of the figure. In the case that the accelerator opening degree is held at a constant level in the isochronous control, the engine speed is substantially maintained at a speed that accords with the accelerator opening degree, and thus the fuel injection quantity has the characteristic of changing in accordance with required torque. Note that, in FIG. 3, the solid line shows a limit value of the fuel injection quantity with respect to the engine speed.

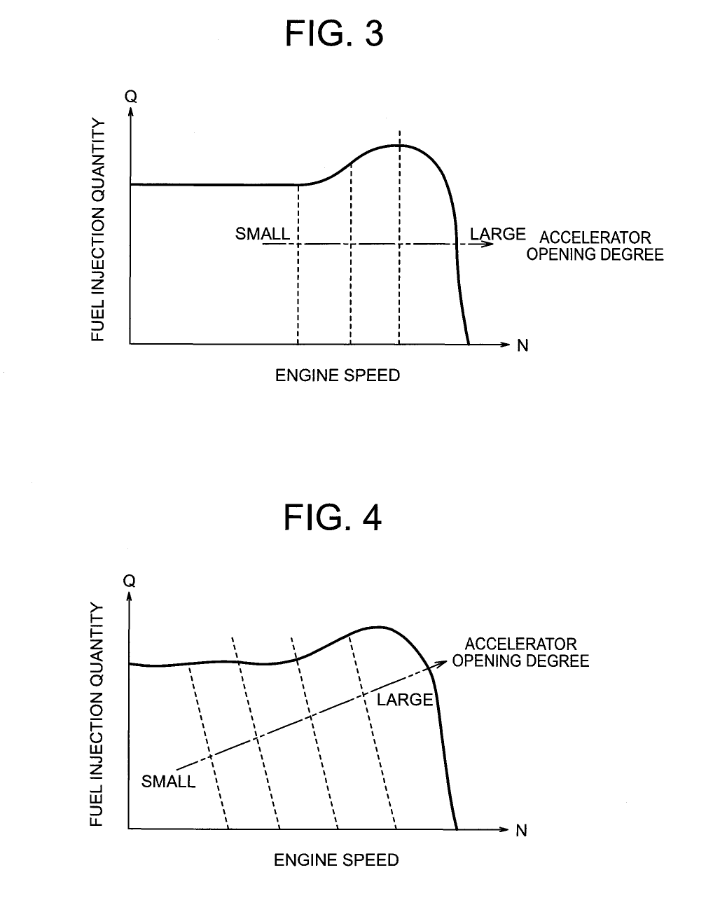

On the other hand, the “load following prioritization mode” is a control that changes the engine speed in accordance with load fluctuation (refer to FIG. 4), and is one type of engine speed control, namely, a droop control.

Note that, FIG. 4 is a schematic characteristic diagram that schematically shows a relationship between the engine speed and the fuel injection quantity with relation to the accelerator opening degree in the above mentioned droop control.

In the figure, the horizontal axis shows the engine speed N, and the vertical axis shows the fuel injection quantity Q. Moreover, the various dotted lines are characteristic lines that schematically show changes in the fuel injection quantity with respect to the engine speed at various accelerator opening degrees.

The accelerator opening degree, as shown by the two-dot chain line, increases toward the right side of the figure. In the case that the accelerator opening degree is held at a constant level in the droop control, when the engine speed decreases, or in other words, when load increases, the fuel injection quantity has the characteristic of increasing. The inclination of the dotted lines is less than in the case of the previously described isochronous control, but compared to a standard vehicle the inclination is steeply sloping. Note that, in FIG. 4, the solid line shows a limit value of the fuel injection quantity with respect to the engine speed.

In the embodiment of the invention, even if the vehicle user does not have in-depth knowledge concerning engine speed control like isochronous control and droop control, it is possible for the above described two controls to be selectable as a result of giving the control names that allow the function of the operation mode to be comprehended by the vehicle user.

Next, in step S102, if it is determined that a switching request for the engine speed control mode has been generated (in the case of YES), the routine advances to the processing at step S104 that is described next. On the other hand, if it is determined that a switching request for the engine speed control mode has not been generated (in the case of NO), there is no need to perform the series of processes and thus the routine returns to a main routine that is not shown in the figures.

At step S104, it is determined whether or not a constant speed prioritization mode switching request has been made, and if it is determined that a constant speed prioritization mode switching request has been made (in the case of YES), the routine advances to the processing at step S106 that is described next. On the other hand, if it is determined that a constant speed prioritization mode switching request has not been made (in the case of NO), it is assumed that a load following prioritization mode switching request has been made and the routine advances to the processing at step S108 described later.

In other words, in the embodiment of the invention, the processing performed if a switching request is generated for switching from the load following prioritization mode to the constant speed prioritization mode (in the case of YES at step S104), and the processing performed if a switching request is generated for switching from the constant speed prioritization mode to the load following prioritization mode (in the case of NO at step S104) is the same processing from step S108 onwards.

At step S106, initialization of an integral term (I-term) in the engine speed control is performed. More particularly, the isochronous control is fundamentally performed using feedback control that uses PID control, and at step S106, initialization of an integral term in the PID control is performed. In the initialization of the integral term in the embodiment of the invention, a target fuel injection quantity Q set immediately before a switching request for the control mode is generated (refer to step S102 of FIG. 2) is set as an initial value of the integral term.

Note that, the target fuel injection quantity Q is computed in fuel injection quantity control processing that is performed in the main routine, not shown in the figures, in a similar manner to that in known devices. It is favorable if this computed target fuel injection quantity Q is also used in this processing.

Next, computation is performed of the accelerator opening degree that is used after switching the engine speed control mode from the constant speed prioritization mode to the load following prioritization mode or after switching the engine speed control mode from the load following prioritization mode to the constant speed prioritization mode (refer to step S108 in FIG. 2).

More specifically, computation is performed of an accelerator opening degree vAcc (hereafter referred to as a “virtual accelerator opening degree” for ease of explanation) in the engine speed control mode for after switching of the engine speed control mode such that the engine speed is substantially the same as the engine speed at the accelerator opening degree of the engine speed control mode before switching the engine speed control mode.

The computation of the accelerator opening degree for use after switching of the engine speed control mode is performed using computation with a predetermined arithmetic expression that is based on the engine speed immediately prior to switching and the target fuel injection quantity Q. The described arithmetic expression is based on the results of experiments, simulations etc., and is set whilst taking into account the specific requirements etc. of individual vehicles.

Next, it is determined whether or not the virtual accelerator opening degree vAcc computed in the above described manner is greater than an actual accelerator opening degree aAcc (refer to step S110 in FIG. 2).

Then, at step S110, if the virtual accelerator opening degree vAcc is greater than the actual accelerator opening degree aAcc (in the case of YES), the processing advances to step S112 described next. On the other hand, if it is determined that the virtual accelerator opening degree vAcc is not greater than the actual accelerator opening degree aAcc (in the case of NO), the routine advances to the processing at step S120 described later.

At step S112, based on the determination result of the earlier step S104, the driving mode is switched, ie, the engine speed control is switched from the load following prioritization mode to the constant speed prioritization mode or from the constant speed prioritization mode to the load following prioritization mode. In addition, engine speed control is performed in the constant speed prioritization mode or the load following prioritization mode, using the virtual accelerator opening degree vAcc.

In this manner, if it is determined that the virtual accelerator opening degree vAcc is greater than the actual accelerator opening degree aAcc (refer to step S110 of FIG. 2), switching of the engine speed control mode is performed. This is because the engine speed becomes even lower than that immediately before switching if switching of the engine speed control mode is performed when the virtual accelerator opening degree vAcc is not greater than the actual accelerator opening degree aAcc, and this causes the effect that the driver feels that driving feeling has worsened.

Next, it is determined whether or not the actual accelerator opening degree aAcc is greater than the virtual accelerator opening degree vAcc (refer to S114 of FIG. 2). If it is determined that the actual accelerator opening degree aAcc is greater than the virtual accelerator opening degree vAcc (in the case of YES), the engine speed control continues with the actual accelerator opening degree aAcc rather than the virtual accelerator opening degree vAcc (refer to step S116 of FIG. 2), and with that the routine returns to the main routine not shown in the figures.

Further, at step S114, if it is determined that the actual accelerator opening degree aAcc is not greater than the virtual accelerator opening degree vAcc (in the case of NO), it is determined whether or not a first predetermined change of the actual accelerator opening degree aAcc has occurred (refer to step S118 of FIG. 2).

More specifically, in the embodiment of the invention, it is determined whether or not an increase amount of the actual accelerator opening degree aAcc (the first predetermined change) from the time at which the driving mode was switched (refer to step S112 of FIG. 2) exceeds a first predetermined amount. If it is determined that the increase amount of the actual accelerator opening degree aAcc exceeds the first predetermined amount (in the case of YES), the routine advances to the processing of step S116 described previously. On the other hand, if it is determined that the increase amount of the actual accelerator opening degree aAcc has not exceeded the first predetermined amount (in the case of NO), the routine returns to the processing of the previous step S114, and, following that, processing that is the same as that previously explained is repeated.

Note that, when deciding what value to set for the first predetermined amount, all of the requirements etc. of each individual vehicle should be considered and a suitable value should be set in each case. Thus, the value should not be limited to a particular value.

Further, the details of the first predetermined change need not be limited to the example described above, and the first predetermined change may be set appropriately in accordance with all of the requirements etc. of each individual vehicle.

Here, it is favorable to use the following examples as specific processing examples of step S118.

As a first example, it is determined whether or not a deviation between the actual accelerator opening degree aAcc and the virtual accelerator opening degree vAcc is less than a predetermined value, and if it is determined that the difference is less than the predetermined value, switching to the actual accelerator opening degree aAcc is performed and the processing of step S116 is performed. On the other hand, if it is determined that the deviation is not less than the predetermined value, the routine returns to the processing at step S114.

In a second example, it is determined whether or not the actual accelerator opening degree aAcc has increased by a predetermined value or more since the time when the driving mode was switched (step S112 of FIG. 2). If it is determined that the actual accelerator opening degree aAcc has increased by the predetermined value or more, switching to the actual accelerator opening degree aAcc is performed and the processing of step S116 is performed. On the other hand, if it is determined that the actual accelerator opening degree aAcc has not increased by the predetermined value or more, the routine returns to the processing at step S114.

Note that, in the case that the processing of the second example is used, it is advantageous from the point of view that switching is performed in a state in which the deviation between the virtual accelerator opening degree vAcc and the actual accelerator opening degree aAcc is small, and thus the speed variation is kept to a small amount.

As a third example, it is determined whether or not the actual accelerator opening degree aAcc has decreased by a predetermined value or more since the time when the driving mode was switched (step S112 of FIG. 2). If it is determined that the actual accelerator opening degree aAcc has decreased by the predetermined value or more, switching to the actual accelerator opening degree aAcc is performed and the processing of step S116 is performed. On the other hand, if it is determined that the actual accelerator opening degree aAcc has not decreased by the predetermined value or more, the routine returns to the processing at step S114.

Note that, in the case that the processing of the third example is used, it is advantageous from the point of view that the vehicle user does not feel any substantial sense of unease concerning vehicle behaviour since the performed accelerator operation accords with the intention of the vehicle user.

As a fourth example, in the case that the actual accelerator opening degree aAcc does not change in a determined time, switching from the virtual accelerator opening degree vAcc to the actual accelerator opening degree aAcc is performed in a state of ramp at a chosen speed by performing the processing of step S116. On the other hand, in the case that the above condition is not satisfied, the routine returns to the processing at step S114.

In a fifth example, if the actual engine speed has reached a target speed in the constant speed prioritization mode that is calculated based on the actual accelerator opening degree aAcc, switching to the actual accelerator opening degree aAcc is performed and engine speed control using the constant speed prioritization mode is performed. On the other hand, if the above condition is not satisfied, the routine returns to the processing at step S114. Note that, the fifth example can be applied in the case of performing switching to the constant speed prioritization mode from the load following prioritization mode.

Note that, the vehicle model, dimensions etc. should be considered to appropriately select which of the above described processes to use.

On the other hand, at step S120, based on the determination result of the earlier step S104, the driving mode is switched, ie, the engine speed control is switched from the load following prioritization mode to the constant speed prioritization mode or from the constant speed prioritization mode to the load following prioritization mode. In addition, engine speed control is performed in the constant speed prioritization mode or the load following prioritization mode, using the virtual accelerator opening degree vAcc.

Note that, the content of the processing at step S120 is fundamentally the same as the content of the processing at the previously described step S112. In the embodiment of the invention, when switching the engine speed control mode, in the case that the virtual accelerator opening degree vAcc is greater than the actual accelerator opening degree aAcc, the processing from step S114 onwards is performed. On the other hand, if the virtual accelerator opening degree vAcc is not greater than the actual accelerator opening degree aAcc, the processing from step S122 onwards is performed. However, regardless of which processing is performed, when the respective processing is started, at first the virtual accelerator opening degree vAcc is used and after this the processing from step S114 onwards or the processing from step S122 onwards is performed.

Next, it is determined whether or not the actual accelerator opening degree aAcc is less than the virtual accelerator opening degree vAcc (refer to step S122 of FIG. 2), and if it is determined that the actual accelerator opening degree aAcc is less than the virtual accelerator opening degree vAcc (in the case of YES), the routine advances to the processing of the previously described step S116.

On the other hand, if it is determined that the actual accelerator opening degree aAcc is not less than the virtual accelerator opening degree aVcc at step S122 (in the case of NO), it is determined whether or not a second predetermined change of the actual accelerator opening degree aAcc has occurred (refer to step S124 of FIG. 2).

More specifically, in the embodiment of the invention, it is determined whether or not an increase amount of the actual accelerator opening degree aAcc (the second predetermined change) from the time at which the driving mode was switched (refer to step S120 of FIG. 2) exceeds a second predetermined amount. If it is determined that the increase amount of the actual accelerator opening degree aAcc exceeds the second predetermined amount (in the case of YES), the routine advances to the processing of step S116 described previously. On the other hand, if it is determined that the increase amount of the actual accelerator opening degree aAcc has not exceeded the second predetermined amount (in the case of NO), the routine returns to the processing of the previous step S122, and, following that, processing that is the same as that previously explained is repeated.

Note that, when deciding what value to set for the second predetermined amount, all of the requirements etc. of each individual vehicle should be considered and a suitable value should be set in each case. Thus, the value should not be limited to a particular value. In addition, the second predetermined amount may be set to be the same as the previously described first predetermined amount (refer to step S118 of FIG. 2).

Further, the details of the second predetermined change need not be limited to the example described above, and the second predetermined change may be set appropriately in accordance with all of the requirements etc. of each individual vehicle.

Here, it is favorable to use the following examples as specific processing examples of step S124.

As a first example, it is determined whether or not a deviation between the actual accelerator opening degree aAcc and the virtual accelerator opening degree vAcc is less than a predetermined value, and if it is determined that the deviation is less than the predetermined value, switching to the actual accelerator opening degree aAcc is performed and the processing of step S116 is performed. On the other hand, if it is determined that the difference is not less than the predetermined value, the routine returns to the processing at step S122.

In a second example, it is determined whether or not the actual accelerator opening degree aAcc has decreased by a predetermined value or more since the time when the driving mode was switched (step S112 of FIG. 2). If it is determined that it has decreased by the predetermined value or more, switching to the actual accelerator opening degree aAcc is performed and the processing of step S116 is performed. On the other hand, if it is determined that the actual accelerator opening degree aAcc has not decreased by the predetermined value or more, the routine returns to the processing at step S122.

Note that, in the case that the processing of the second example is used, it is advantageous in that switching is performed in a state in which the deviation between the virtual accelerator opening degree vAcc and the actual accelerator opening degree aAcc is small, and thus the speed variation is kept to a small amount.

In a third example, it is determined whether or not the actual accelerator opening degree aAcc has increased by a predetermined value or more since the time when the driving mode was switched (step S112 of FIG. 2). If it is determined that the actual accelerator opening degree aAcc has increased by the predetermined value or more, switching to the actual accelerator opening degree aAcc is performed and the processing of step S116 is performed. On the other hand, if it is determined that the actual accelerator opening degree aAcc has not increased by the predetermined value or more, the routine returns to the processing at step S122.

Note that, in the case that the processing of the third example is used, it is advantageous from the point of view that the vehicle user does not feel any substantial sense of unease concerning vehicle behaviour since the performed accelerator operation accords with the intention of the vehicle user.

As a fourth example, in the case that the actual accelerator opening degree aAcc does not change in a determined time, switching from the virtual accelerator opening degree vAcc to the actual accelerator opening degree aAcc is performed in a state of ramp at a chosen speed by performing the processing of step S116. On the other hand, in the case that the above condition is not satisfied, the routine returns to the processing at step S122.

In a fifth example, if the actual engine speed has reached a target speed in the constant speed prioritization mode that is calculated based on the actual accelerator opening degree aAcc, switching to the actual accelerator opening degree aAcc is performed and engine speed control using the constant speed prioritization mode is performed. On the other hand, if the above condition is not satisfied, the routine returns to the processing at step S122. Note that, the fifth example can be applied in the case of performing switching to the constant speed prioritization mode from the load following prioritization mode.

Note that, the vehicle model, dimensions etc. should be considered to appropriately select which of the above described processes to use.

In the above described embodiment of the invention, a case is explained in which the engine speed control mode switching method according to the invention is applied to a common rail fuel injection control device that is taken as an example of the fuel injection control device for the internal combustion engine. However, the fuel injection control device of the internal combustion engine is not necessarily limited to a common rail fuel injection control device and it may be another type of device.

The invention may be applicable to a vehicle in which smooth switch between the droop control and the isochronous control is desired.

According to the invention, when switching the engine speed control mode, switching of the engine speed control mode is performed at the engine speed state of the engine speed control mode prior to switching. Thus, unlike known art, smooth switching can be achieved without causing the engine to race or speed to decrease, and without causing deterioration in driving feeling.

What is claimed is:

1. An engine speed control mode switching method for use in an engine speed control device which is provided with an electronic control unit that performs operation control of an internal combustion engine and which is capable of performing speed control of the internal combustion engine by selecting and performing one of a droop control and an isochronous control in accordance with a request, the engine speed control mode switching method for switching between the droop control and the isochronous control, comprising:
initializing, when an engine speed control mode switching request is generated for switching from the droop control to the isochronous control, or when an engine speed control mode switching request is generated for switching from the isochronous control to the droop control, a value of an integral term used in PID control that is performed in the isochronous control only when the engine speed control mode switching request is generated for switching from the droop control to the isochronous control, the value of the integral term being initialized based on a target fuel injection quantity used immediately prior to switching, prior to performing steps below;
calculating, thereafter, an accelerator opening degree in a control state after switching of the engine speed control mode, as a virtual accelerator opening degree, using a predetermined arithmetic expression, the accelerator opening degree corresponding to a speed state of the internal combustion engine at an accelerator opening degree used during performance of the engine speed control mode used immediately prior to switching of one of the engine speed control modes;
then, switching the engine speed control mode if the calculated virtual accelerator opening degree is greater than an actual accelerator opening degree, and performing the engine speed control using the virtual accelerator opening degree; and
after the switching, continuing the engine speed control in the engine speed control mode after switching using the actual accelerator opening degree if the actual accelerator opening degree is greater than the virtual accelerator opening degree.

2. The engine speed control mode switching method according to claim 1, further comprising:
switching the engine speed control mode and performing the engine speed control using the virtual accelerator opening degree if the calculated virtual accelerator opening degree is less than the actual accelerator opening degree; and
after the switching step, performing the engine speed control in the engine speed control mode after switching using the actual accelerator opening degree if the actual accelerator opening degree is less than the virtual accelerator opening degree.

3. An engine speed control device provided with an electronic control unit that performs operation control of an internal combustion engine and which is capable of performing speed control of the internal combustion engine by selecting and performing one of a droop control and an isochronous control in accordance with a request, wherein
the electronic control unit initializes, when it is determined that an engine speed control mode switching request has been generated for switching from the droop control to the isochronous control, or when it is determined that an engine speed control mode switching request has been generated for switching from the isochronous control to the droop control, a value of an integral term used in PID control that is performed in the isochronous control only when it is determined that the engine speed control mode switching request has been generated for switching from the droop control to the isochronous control, the value of the integral term being initialized based on a target fuel injection quantity used immediately prior to switching, prior to performing processing below;
thereafter, the electronic control unit calculates, as a virtual accelerator opening degree, an accelerator opening degree in a control state after switching of the engine speed control mode using a predetermined arithmetic expression, the accelerator opening degree corresponding to a speed state of the internal combustion engine at an accelerator opening degree used during performance of the engine speed control mode used immediately prior to switching of one of the engine speed control modes;
then, the electronic control unit switches the engine speed control mode if the calculated virtual accelerator opening degree is greater than an actual accelerator opening degree, and performs the engine speed control using the virtual accelerator opening degree; and
after the switching, the electronic control unit continues the engine speed control in the engine speed control mode after switching using the actual accelerator opening degree if the actual accelerator opening degree is greater than the virtual accelerator opening degree.

4. The engine speed control device according to claim 3, wherein
the electronic control unit switches the engine speed control mode and performs the engine speed control using the virtual accelerator opening degree if it is determined that the calculated virtual accelerator opening degree is less than the actual accelerator opening degree, and
after the switching step, the electronic control unit performs the engine speed control in the engine speed control mode after switching using the actual accelerator opening degree if it is determined that the actual accelerator opening degree is less than the virtual accelerator opening degree.
